(19) United States
(12) Patent Application Publication
(10) Pub. No.: US 2019/0114819 A1
(43) Pub. Date: Apr. 18, 2019

(54) DIMENSIONAL CONTENT SURFACE RENDERING

(71) Applicant: Microsoft Technology Licensing, LLC, Redmond, WA (US)

(72) Inventors: Samuel P. KITE, Lynnwood, WA (US); Andrew J. MORONEY, Seattle, WA (US); Devin BROWN, Bothell, WA (US); Jeffrey S. FLEISCHMANN, Seattle, WA (US); Julian SELMAN, Redmond, WA (US); Adib PARKAR, Redmond, WA (US); Emily Lynn BENDER, Chardon, OH (US)

(21) Appl. No.: 15/783,822

(22) Filed: Oct. 13, 2017

(51) Int. Cl. G06T 13/20

(52) U.S. Cl. CPC G06T 13/20; G06T 17/005; G06T 2210/56

(57) ABSTRACT

In accordance with one implementation, a system for rendering dimensional surface content in a low-memory environment includes a dimensional surface content rendering tool to generate an animation object file defining inputs to a particle system, and an application that generates scene instructions based on output received from the particle system, the scene instructions including coordinate information for rendering an object at a series of positions. The system further includes a graphics engine that autonomously produces a series of draw commands responsive to receipt of the scene instructions to render multiple complete frames of an animation in a window of the application, the animation depicting the object at the series of positions.

### BACKGROUND

Interactive animations are often rendered by high-power gaming engines that include several sub-engines independently managing different animation tasks to ultimately to allow objects to be realistically represented in appearance, movement, and in relation to other objects. For example, game engine architecture may include a rendering engine for rendering 2D or 3D graphics, a physics or collision engine to provide movement and appropriate effects when objects “collide” in the virtual world, engines for artificial intelligence (e.g., to simulate human-like behaviors), engines for audio, memory management, etc. Due to the complex interplay between these different sub-engines, game engines generally utilize large amounts of memory to render even simple video-like interactive animations (e.g., moving a camera around within a video-like scene).

### SUMMARY

A system disclosed herein includes a dimensional surface content rendering tool, an application, and a graphics engine. The dimensional surface content rendering tool generates an animation object file defining inputs to a particle system, and the application generates scene instructions based on output received from the particle system describing coordinate information for rendering an object at a series of positions. The graphics engine autonomously produces a series of draw commands responsive to receipt of the scene instructions to render multiple complete frames of an animation in a window of the application, the animation depicting the object at the series of positions.

This Summary is provided to introduce an election of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTION OF THE DRAWINGS

FIG. 1 illustrates example operations of two systems that render an animation in different ways.

FIG. 2 illustrates an example system for rendering high-resolution animations in low-memory environments utilizing a dimensional surface content rendering tool.

FIG. 3 illustrates further aspects of an example system for rendering high-resolution animations in low-memory environments.

FIG. 4 illustrates example operations for rendering high-resolution animations in low-memory environments.

FIG. 5 illustrates an example schematic of a processing device operable to render a high-resolution animation according to the technology described herein.

### DETAILED DESCRIPTION

Many popular computing devices do not have sufficient memory resources to execute gaming engines without unacceptably degrading device performance. As a result, many applications are unable to deliver high-quality interactive animations to a user. The herein-disclosed technology provides an architecture for delivering high-quality video-animation effects, including interactive effects, in a low-memory environment. In one implementation, the disclosed technology utilizes a small amount of processing power as compared to a traditional (high-power) gaming engine to produce an interactive scene that is of a visual quality comparable to that produced by the gaming engine. For example, the herein disclosed technology facilitates renderings of an interactive video scene with a few hundred megabytes of memory as compared to one or more gigabytes that may be utilized to render a scene of nearly identical visual effects using traditionally-available animation tools.

The herein-disclosed animation tools can be utilized to render animations within a variety of types of applications including those typically supported by powerful processing resources (e.g., gaming systems). However, since these animation tools provide an architecture that adapts traditionally memory-intensive visual effects for similar presentation in lower-memory environments, these tools may be particularly useful in rendering animations within low-memory applications. As used herein, the term “low-memory application” is used broadly to refer to applications that utilize fewer than 5% of the total system memory (e.g., RAM). Low-memory applications may include, for example, a variety of desktop and mobile applications including, without limitation, Universal Windows Platform (UWP) applications, iOS applications, and Android applications.

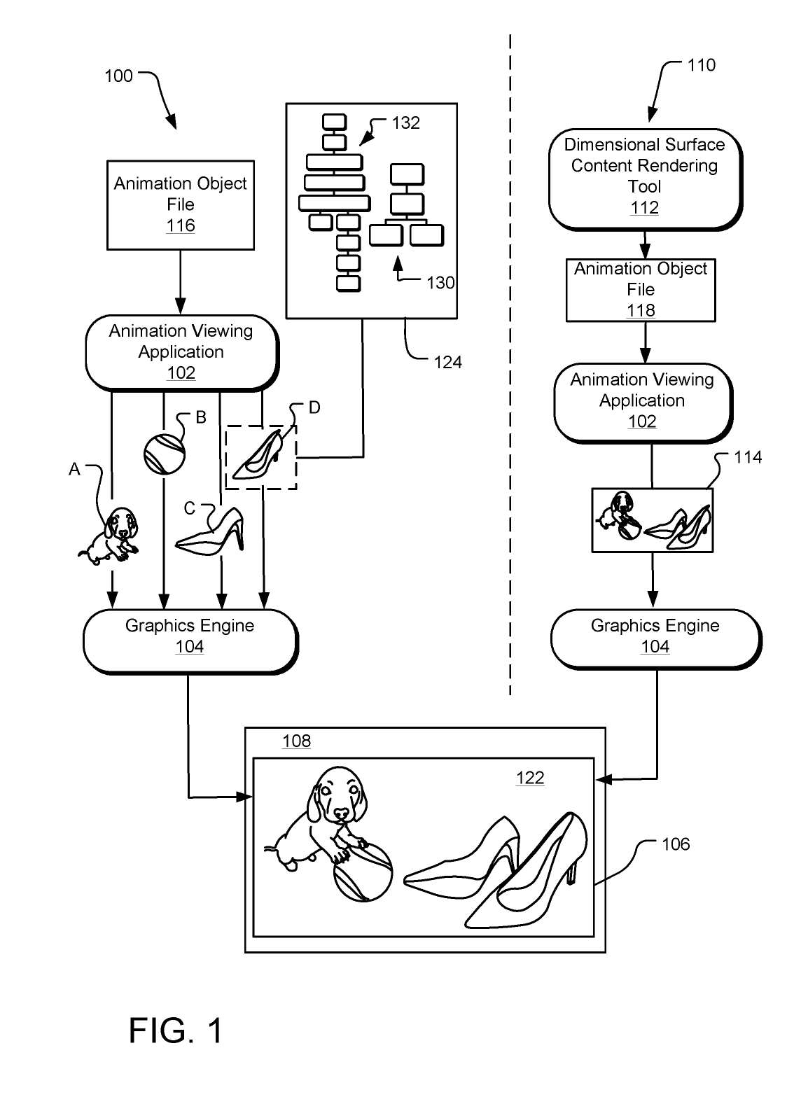

FIG. 1 illustrates example operations of systems 100, 110 for rendering one or more frames of an animation according to two different methodologies. The system 100 (shown on the left side of FIG. 1) performs operations that result in a higher consumption of memory resources than the operations of the system 110 (shown on the right side of FIG. 1).

The system 100 includes an animation viewing application 102 that communicates with a graphics engine 104 to render one or more frames of an animation (e.g., a scene 122) to user interface 106 of the animation viewing application 102 on a display 108. Objects A, B, C, and D to be depicted within the scene 122 are defined in an animation object file 116, which is provided as an input to the animation viewing application 102. The animation viewing application 102 performs operations to read and import each of the objects A, B, C, and D defined within the animation object file 116. For each recognized one of the objects A, B, C, and D, the animation viewing application 102 imports a separate object and creates one or more trees of associated metadata (e.g., example metadata 124 for the object D). According to one implementation, this metadata is used by the graphics engine 104 to determine how to draw each one of the objects A, B, C, and D and how to assemble the different objects with respect to one another in the user interface 106.

On different computing platforms, the object metadata sent to the graphics engine 104 may assume different forms. In FIG. 1, the object metadata (e.g., the example metadata 124) includes a logical tree 130 and a visual tree 132 for each separate one of the objects A, B, C, and D to be rendered in the user interface 106. For example, the logical tree 130 defines hierarchical relations between different interface elements of a scene (e.g., a window, a border within the window, a content presenter element within the border, a grid within the content presenter element, a button within the grid, a text block within the button). The visual tree 132, in contrast, is an expansion of the logical tree 130, and defines visual components for rendering each logical component (e.g., coordinate information, shape information, color information).

To render objects of the animation object file 116 to the display 108, the animation viewing application 102 provides this complex metadata (e.g., one or more tree structures such as the example metadata 124) to the graphics engine 104, and the graphics engine 104 uses such information to determine how to present each of the objects A, B, C, and D relative to one another in the user interface 106. For example, the animation viewing application 102 may transmit a separate “draw” command for each one of the objects A, B, C, and D of the scene 122 along with the associated complex metadata to request rendering of each of the objects in a same scene alongside one another. In one implementation, the animation viewing application 102 sends a separate series of draw commands for each frame of the scene (e.g., a multi-frame animation). For example, four draw commands are sent to render objects A, B, C, and D at first positions in a first frame. Another four draw commands are sent to render the objects A, B, C, and D at second positions in a second frame, and further similar sets of commands similarly transmitted to render the third frame, fourth frame, fifth frame, etc. In this sense, rendering the multi-frame animation entails repeated transmission of complex metadata for each object and each frame in which the object appears.

The graphics engine 104 processes the complex metadata 124 in association with each individual object for each frame of the animation and uses such information to determine where to draw the objects A, B, C, and D and how to layer the objects in order to render individual frames of the animation. In this sense, the objects A, B, C, and D, are not associated with a same scene or frame until the graphics engine 104 creates the objects according to the complex metadata 124 and aggregates the objects within a same virtual surface by determining proper spacing, layering (e.g., object overlap order), etc.

Complex graphics structures, such as the tree data representing each of the scene components A, B, C, and D, are memory-intensive. Rendering animations as described above (e.g., repeated “draw” calls for each individual object) can be memory-intensive, particularly when the individual objects are complex (e.g., complex, multi-attribute trees), high-resolution, and/or when independent motion is desired for multiple objects in a frame. In these cases, animation rendering may come at the expense of system delays that are inconvenient and annoying for a user. Making these types of animations interactive (e.g., such as by allowing a user to provide input to “explore” a virtual scene), is even more memory intensive because the executed sequence of “draw” commands may change based on user input. For this reason, interactive animations are typically rendered with a gaming engine (not shown) supported by powerful processing resources that are capable of determining how different objects interact in different scenarios. However, gaming engines are cost prohibitive in a large number of systems in which animations are desired.

In contrast to the operations described above with respect to the system 100, the operations shown on the right side of FIG. 1 with respect to the system 110 allow for renderings of the same scene 122 in the user interface 106 of the animation viewing application 102 while utilizing fewer memory resources. Like the system 100, the system 110 includes the animation viewing application 102 that communicates with a graphics engine 104 to render the animation. The system 110 further includes a dimensional surface content rendering tool 112 that defines an animation object file 118 for input into the animation viewing application 102.

The animation object file 118 organizes and defines graphics data according to a format that is different from the complex metadata (e.g., tree structures) explained with respect to the animation object file 116 of the system 100. In one implementation, the animation object file 118 defines a particle system that is stored in memory as one object, and the animation object file 118 further defines inputs for initializing a particle system that creates (e.g., “spawns”) of each one of the objects A, B, C, and D at a predetermined time according to a predefined set of behaviors.

The animation viewing application 102 initiates the particle system per the inputs specified in the animation object file 118, and provides outputs of the particle system to the graphics engine 104 in the form of scene instructions 114. In one implementation, the scene instructions 114 provide the graphics engine 104 with complete instructions for autonomously generating coordinates for each of the objects A, B, C, and D in each of multiple frames of the scene 122. Due to the structure of the scene instructions 114 (discussed in greater detail below), the graphics engine 104 does not determine spatial relationships between the objects A, B, C, and D in the scene 122. For example, the graphics engine 104 does not determine a layering order that governs which objects are displayed on top in the event of overlap. Rather, the graphics engine 104 is able to draw one or more complete frames of the scene 122 without traditional processing to assimilate various objects of each frame, as if the entire scene were an individual object rather than a collection of individually-defined objects.

In one implementation, the graphics engine 104 creates one object in a graphics layer representing the scene 122. This single object allows all of the objects A, B, C, and D of the application layer to be rendered simultaneously. As a result, the graphics engine 104 can render the scene 122 without any additional “work” to determine where to place the objects A, B, C, and D relative to one another and without performing calculations to determine how placement of one scene component affects another on the virtual surface (e.g., “collision” calculations).

In one implementation, the animation viewing application 102 can instruct the graphics engine 104 to add one or more new scene components to an ongoing (e.g., currently rendering) animation by sending an update to the scene instructions 114, which the graphics engine 104 dynamically implements without interrupting the animation. These and other advantages of the disclosed technology are discussed in detail with respect to the following figures.

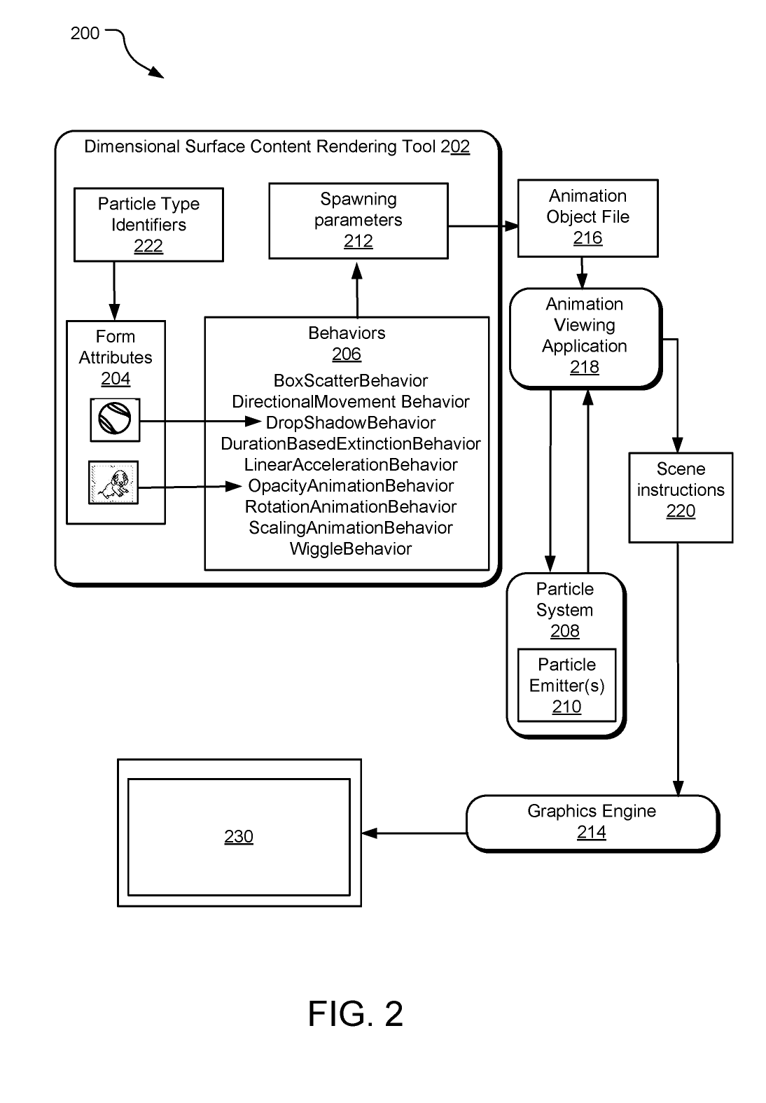

In different implementations, the scene instructions 114 may include different content generated in different ways. One detailed example of the scene instructions 114 is discussed with respect to FIG. 2, below.

FIG. 2 illustrates an example system 200 for rendering high-resolution animations in low-memory environments utilizing a dimensional surface content rendering tool 202. In one implementation, the dimensional surface content rendering tool 202 is the same as the dimensional surface content rendering tool 112 discussed above with respect to FIG. 1.

The dimensional surface content rendering tool 202 is an application or tool (e.g., an add-on to an animation-developing platform) that provides a user interface for generating an animation object file 216. The animation object file 216 organizes graphical information (e.g., images, objects) in a manner that enables an animation viewing application 218 to generate scene instructions 220 effective to enable the graphics engine 214 to autonomously produce a series of draw commands to render multiple complete frames of an animation. In one implementation, the animation viewing application 218 has access to a common run-time library (not shown) utilized by the dimensional surface content rendering tool 202 in generating the animation object file 216. Responsive to receipt of the animation object file 216, the animation viewing application 218 and/or modules in a run-time library (not shown) of the animation viewing application 218 identify and create object(s) defined in the animation object file 216. For example, the animation object file 216 is an XML file with objects that can be identified, imported, and exported by run-time modules accessible within a common application platform, such as the .NET framework. The animation viewing application 218 may, for example, be any C# or XAML program with access to libraries of the .NET framework

In one implementation, the animation object file 216 defines a particle system 208 with one or more defined particle data objects. The animation viewing application 218 uses information within the animation object file 216 to prepare inputs to a particle system 208 and to initialize the particle system 208 with the inputs. The particle system 208, in turn, emits particles, determines coordinate information for each emitted particle (e.g., a time-dependent position function), and conveys this coordinate information back to the animation viewing application 218. The animation viewing application 218 uses outputs of the particle system 208 to generate scene instructions 220 for rendering an animation of the particle(s) within a window 230 of the animation viewing application 218.

In general, the particle system 208 includes one or more particle emitters 210 that emit particle(s) from a defined emitter location. According to one implementation, each one of the particle emitters 210 emits particles of a same particle type. Thus, multiple particle emitters may be initialized to generate particles of non-identical form. For example, an animation with two dust particles of different sizes may be generated with two different particle emitters.

FIG. 2 shows a number of example inputs to the dimensional surface content rendering tool 202 usable to define input parameters of the particle system 208. These example inputs include without limitation the particle type identifiers 222, form attributes 204, behaviors 206, and spawning parameters 212. In creating the animation object file 216 with the dimensional surface content rendering tool 202, a user (developer) defines or selects a particle type identifier 222 (e.g., an identifier used to denote a class of particles). The user also indicates one or more of the form attributes 204 usable by the graphics engine 214 to determine the physical appearance for each particle emitted by the particle system 208. The form attributes 204 may, for example, define information pertaining to shape, color, shading, etc., of each particle. In one implementation, the user defines an image as one of the form attributes 204 associated with a specified one of the particle type identifiers 222. For example, the user uploads or specifies a .PNG image and upon subsequent initialization, the particle emitter 210 spawns one or more instances of the .PNG image according to a predefined size. In some instances, the form attributes 204 may not include an image. For example, the form attributes may include graphical vector information for drawings a particle shape, coloring an area of the screen, etc.

In addition to defining the form attributes 204 for each defined particle type, the dimensional content surface rendering tool 202 also facilitates selection of one or more of the behaviors 206 to be applied to each particle spawned by the particle system 208. In one implementation, the dimensional surface content rendering tool 202 provides the user with a selection (e.g., a menu) of pre-defined “behaviors.” For example, each one of the behaviors 206 represents a package of pre-defined related attributes that provide a commonly desired animation effect. Thus, the behaviors 206 collectively represent a subset of commonly desired animations and effects. In different implementations, the behaviors 206 may take on a variety of forms based, in part, upon the particular types of animations that the dimensional surface content rendering tool 202 is designed to provide. A few example behaviors are shown in FIG. 2 (e.g., a predefined rotation or acceleration effect, wiggle effect, alteration of opacity, etc.).

Using the behaviors 206 to provide animation effects simplifies the animation of each object in 3D quickly, greatly reducing the time and complexity of generating motion for each individual particle. Moreover, the behaviors 206 can be reused for particles of identical type, simplifying the amount of information that is conveyed to the graphics engine 214 and allowing for on-the-fly updates to an animation that is currently running.

In addition to the above-described inputs for defining the form attribute(s) 204 and one or more behaviors 206 for each particle type identifier 222, the dimensional surface content rendering tool 202 also allows the user to define various spawning parameters 212 of the particle system 208. The spawning parameters 212 define further information for initially creating each particle including, for example, a spawning rate (how many particles are generated per unit of time), the initial velocity vector of each particle (e.g., the direction particles are emitted upon creation), and particle lifetime (e.g., the length of time each individual particle exists before disappearing). In some implementations, one or more of the particle types 222, form attributes 204, spawning parameters 212, and behaviors 206 may be set by dimensional surface content rendering tool 202, such as according to default values rather than user selection.

The above-described particle system inputs (e.g., the particles type identifier(s) 222, the form attribute(s) 204, the behavior(s) 206, and the spawning parameters (212) provide complete information for generating an animated scene with objects controlled by the particle system 208. Responsive to receipt of these inputs and/or further directional instruction from the user, the dimensional surface content rendering tool 202 creates the animation object file 216.

In one implementation, the animation object file 216 is a markup language file, such as an XML file that defines different objects denoted by tags interpretable by a reader in a run-time library (not shown) of the animation viewing application 218. For example, the animation object file 216 includes a “particle system” object having an identifier associated in memory with instructions for imitating a particle system that the animation viewing application 218 automatically executes upon reading of the animation object file 216. Once the animation object file 216 is generated by the dimensional surface content rendering tool 202, a variety of applications with access to a common run-time library may be able to interpret the animation object file 216 to generate and transmit the scene instructions 220.

One example of the animation object file 216 output by the dimensional surface content rendering tool 202 is shown below:

```
?xml version=“1.0” encoding=“utf-8”?>
  <CompositeBackground Version=“0.1.6.0” Width=“1920” Height=“1080”>
    <Image Size=“1920,1080” Name=“Background.png” Source=“Background.png”
NormalizedOffset=“0.000, 0.000” Z=“0” Scale=“1” />
    <ParticleSystem Name=“Particle_3.png”>
    <Emitters>
      <EmitterWithNormalizedOffset Name=“Particle_3.png − 1”
MaxNumberOfParticlesOnScreen=“200” ParticleSpawnRatePerSecond=“3”
ParticleLifetimeInSeconds=“3” TotalNumberOfParticlesToSpawn=“−1” Radius=“0,
450.0062” NormalizedOffsetVector=“0.585, 0.266, 0” />
    </Emitters>
    <Behaviors>
      <OpacityAnimationBehavior MaxOpacity=“0.149999991”
NormalizedKeyframeTimingForMaxOpacity=“0.48” />
      <LinearAccelerationBehavior Velocity=“{ {M11:0 M12:10} {M21:0 M22:20}
{M31:0 M32:0} }” Acceleration=“{ {M11:0 M12:5} {M21:0 M22:5} {M31:0 M32:0} }” />
    </Behaviors>
    <Sprites>
      <Sprite Size=“116,116” Source=“Particle_3.png” Scale=“1” />
    </Sprites>
    </ParticleSystem>
    <ParticleSystem Name=“Console.png”>
    <Emitters>
      <EmitterWithNormalizedOffset Name=“Console.png − 1”
MaxNumberOfParticlesOnScreen=“1” ParticleSpawnRatePerSecond=“1”
ParticleLifetimeInSeconds=“1000” TotalNumberOfParticlesToSpawn=“1” Radius=“0,
37.3457” NormalizedOffsetVector=“0.374, 0.348, 0” />
    </Emitters>
    <Behaviors>
      <WiggleBehavior OscillationPeriod=“10” OscillationMagnitude=“10” Direction=“0”
VelocityRange=“{ {M11:0 M12:0} {M21:0 M22:0} {M31:0 M32:0} }”
AccelerationRange=“{ {M11:0 M12:0} {M21:0 M22:0} {M31:0 M32:0} }” />
    </Behaviors>
    <Sprites>
      <Sprite Size=“1543,1270” Source=“Console.png” Scale=“1” />
    </Sprites>
    </ParticleSystem>
    <ParticleSystem Name=“Particle_1.png”>
    <Emitters>
      <EmitterWithNormalizedOffset Name=“Particle_1.png − 1”
MaxNumberOfParticlesOnScreen=“10” ParticleSpawnRatePerSecond=“3”
ParticleLifetimeInSeconds=“3” TotalNumberOfParticlesToSpawn=“−1” Radius=“3.24176,
487.639” NormalizedOffsetVector=“0.704, 0.414, 100” />
    </Emitters>
    <Behaviors>
      <WiggleBehavior OscillationPeriod=“1” OscillationMagnitude=“3” Direction=“0”
VelocityRange=“{ {M11:0 M12:20} {M21:0 M22:30} {M31:0 M32:0} }”
AccelerationRange=“{ {M11:0 M12:20} {M21:0 M22:20} {M31:0 M32:0} }” />
      <OpacityAnimationBehavior MaxOpacity=“0.099999994”
NormalizedKeyframeTimingForMaxOpacity=“0.459999979” />
      <LinearAccelerationBehavior Velocity=“{ {M11:0 M12:20} {M21:0 M22:0}
{M31:20 M32:20} }” Acceleration=“{ {M11:0 M12:50} {M21:30 M22:30} {M31:0 M32:0}
}” />
    </Behaviors>
    <Sprites>
      <Sprite Size=“49,48” Source=“Particle_1.png” Scale=“1” />
    </Sprites>
    </ParticleSystem>
    <ParticleSystem Name=“Controller.png”>
    <Emitters>
      <EmitterWithNormalizedOffset Name=“Controller.png − 1”
MaxNumberOfParticlesOnScreen=“1” ParticleSpawnRatePerSecond=“1”
ParticleLifetimeInSeconds=“1000” TotalNumberOfParticlesToSpawn=“1” Radius=“0, 50”
NormalizedOffsetVector=“0.625, 0.474, 250” />
    </Emitters>
    <Behaviors>
      <WiggleBehavior OscillationPeriod=“10” OscillationMagnitude=“30” Direction=“0”
VelocityRange=“{ {M11:0 M12:0} {M21:0 M22:0} {M31:0 M32:0} }”
AccelerationRange=“{ {M11:0 M12:0} {M21:0 M22:0} {M31:0 M32:0} }” />
      <DropShadowBehavior Offset=“&lt;−150, 80, −30&gt;” Color=“255,0,20,0”
Opacity=“0.6” BlurRadius=“50” />
    </Behaviors>
    <Sprites>
      <Sprite Size=“661,472” Source=“Controller.png” Scale=“1” />
    </Sprites>
    </ParticleSystem>
  </CompositeBackground>
```

The animation viewing application 218 and/or associated run-time modules determine how to import and initialize the particle system 208 according to the inputs specified in the animation object file 216. Upon initialization, the particle system 208 spawns one or more initial particles.

Responsive to emission (spawning) of a first particle, the particle system 208 performs work to determine coordinate information for each particle. In one implementation, the particle system 208 determines a time-dependent position function for each individual particle. If multiple particles are simultaneously spawned, a time-dependent position function may be generated for each individual particle. For example, the position function for each particle is determined based on an aggregate of the parameters initially set within the dimensional surface content rendering tool 202, such as based on an initial velocity vector (e.g., specified by the spawning parameters 212), emission coordinates (e.g., defined by the position of the emitter), and any behavior(s) 206 that have been selected for the particle. The particle system 208 then outputs coordinate information (e.g., the time-dependent position function) to the animation viewing application 218, and the animation viewing application 218 prepares scene instructions 220 for rendering particles emitted by the particle system 208. For example, the scene instructions 220 include the coordinate information from the particle system 208 and the form attributes 204 included in the animation object file 216. The scene instructions 220 are transmitted to the graphics engine 214.

The graphics engine 214 represents a number of elements traditionally present in a graphics pipeline and may, in some implementations, also include one or more intermediary layers that prepare the outputs from the animation viewing application 218 for input to a graphics pipeline. In general, the graphics engine 214 receives graphics-related requests from the animation viewing application 218, prepares the requests for execution by graphics-rendering hardware, such as a graphics card or computer-processing unit (CPU), and controls the graphics-rendering hardware to execute the graphics-related requests and render the requested data to a display. In different implementations, the graphics engine 214 may include different layers and sub-engines that perform different functions.

In one implementation, the scene instructions 220 are formatted according to a graphics layer API that is utilized by the graphics engine 214. The scene instructions 220 are effective to cause the graphics engine 214 to autonomously generate a series of draw commands to render a sequence of frames representing equally-separated points in time throughout the lifetime of at least one emitted particle. If, for example, the animation object file 216 defines a particle with a lifetime of four seconds, the scene instructions 220 are effective to cause the graphics engine 214 to autonomously generate draw commands for rendering the particle in each of multiple frames of an animated scene to be displayed over a time span of four seconds. The graphics engine 214 may, for example, plug a time index value into a received time-dependent position function for a particle to determine the position of the particle in each frame of the animation.

Due to the structure and nature of information included in the scene instructions 220 (e.g., time-dependent position functions for one or more particles), the graphics engine 214 is able to render a multi-frame animation without determining spatial relationships between the different moving objects in the scene. For example, the graphics engine 214 does not determine a layering order that governs which objects are displayed on top in the event of overlap. Rather, the graphics engine 214 is able to create an animation reflecting the entire lifetime of a spawned particle by simply plugging in time values and drawing what the scene instructions 220 indicate for each point in time.

In one implementation, the animation viewing application 218 updates the scene instructions 220 automatically responsive to the spawning of each new particle defined in the animation object file 216. If, for example, a single particle is initially emitted, the scene instructions 220 may initially include form attributes (e.g., size, shape, color(s)) and coordinate information output by the particle system sufficient to render an animation of the single particle throughout the particle's lifetime. When the particle system 208 emits a second particle at a time following emission of the first particle, the particle system 208 outputs coordinate information for the second particle and the animation viewing application 218 updates the scene instructions 220 to include the coordinate information for rendering the second particle over the course of an associated defined lifetime. The animation-viewing application 218 sends the updated coordinate information to the graphics engine 214, and the graphics engine 214 updates the animation to include both particles positioned according to the coordinate information in the scene instructions 220.

In one implementation, the graphics engine 214 does not determine an order in which to render or layer the particles; rather, particles are rendered exactly according to the conveyed coordinate information, such as in the order that it is received. If the animation is already rendering at the time that an update is received, the graphics engine 214 can implement the update (e.g., adding a new particle(s) to the scene) without interrupting the animation. This is a significant improvement over some existing animation solutions that entail recompiling an entire animation whenever a new object is added to the animation.

In one implementation, the above-described technology is usable to implement a high-resolution interactive animated scene, such as a screen-saver or menu that allows a user to provide directional input (scrolling, clicking, etc.) to navigate around the scene (e.g., to explore a mini virtual world). Such interactivity may, for example, be realized by defining a single virtual camera in association with an animated scene. Systems that track complex metadata in association with each object (e.g., as described with respect to the system 100 of FIG. 1) may include virtual cameras in association with each independent object and combine outputs from the multiple cameras to assimilate all of the different objects in a same scene. In the presently-disclosed system, this interactivity is simplified dramatically due to the fact that the graphics engine 214 effectively handles the entire scene as a single object.

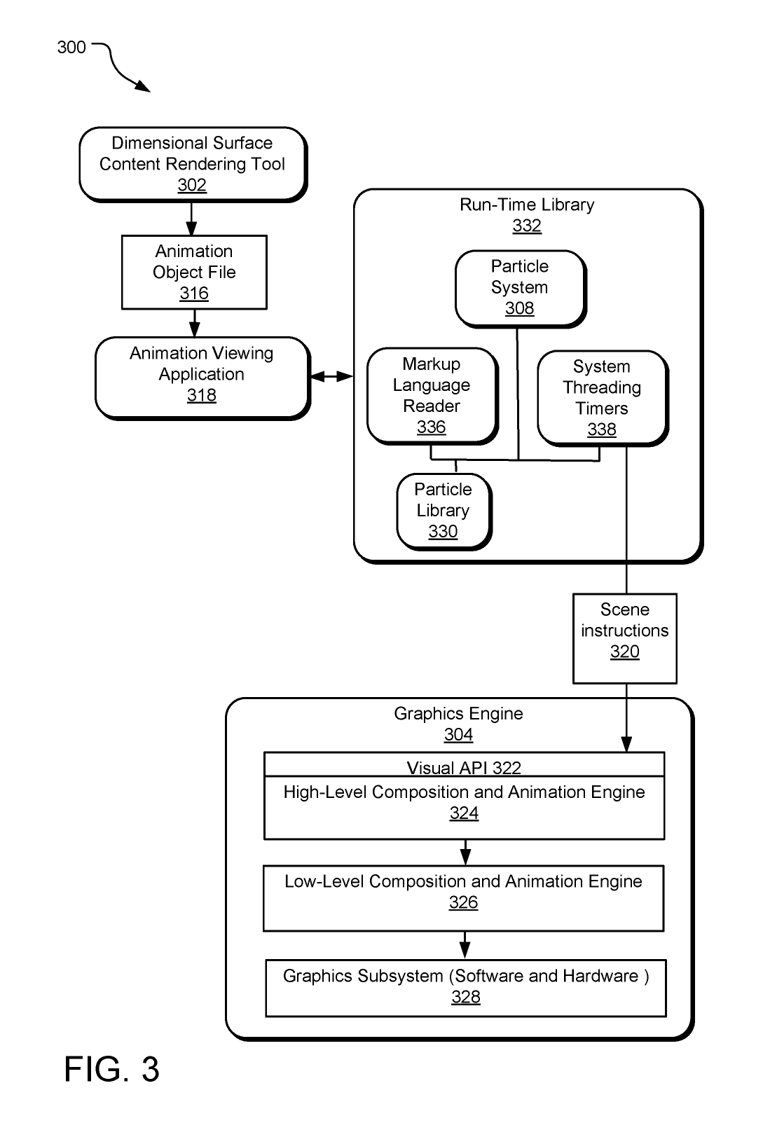

FIG. 3 illustrates further aspects of an example system 300 for rendering high-resolution animations in low-memory environments. The system 300 includes a dimensional surface content rendering tool 302 that provides a user interface for producing an animation object file 316 defining objects to be rendered in a window of animation viewing application 318. In one implementation, the dimensional surface content rendering tool 302 is the same as the dimensional surface content rendering tools discussed above with respect to FIG. 1 and FIG. 2.

The animation object file 316 defines a particle system object identifiable by a markup language reader 336 (e.g., an XML reader) included within a run-time library 332 accessible by the animation viewing application 318. Responsive to receipt of the animation object file 316, the animation viewing application 318 calls upon the markup language reader 336 to read each tag in the animation object file 316 as a separate object. Each object read from the animation object file 316 is checked in sequence for validity against a particle library 330 including identifiers of valid particle objects, and the animation viewing application 318 retrieves and executes instructions (e.g., included within the particle library 330) for creating each object that is identified by the markup language reader 336 as having a corresponding entry in the particle library 330. Based on the retrieved instructions, the animation viewing application 318 initializes (e.g., builds) one or more particle emitters of a particle system 308 according to the inputs included in the animation object file 316, such as by initializing spawning parameters for a particle emitter and applying behaviors to each particle emitted by the emitter.

When initiated, each particle emitter of the particle system 308 calls upon a separate system threading timer (e.g., of system threading timers 338) for managing timing of associated animations. The system threading timers 338 receive outputs from the particle system 308 and prepare scene instructions 320 for transmission to the graphics engine 304. For each new particle generated, the particle system 308 performs calculations to implement any applied behaviors (e.g., behaviors 206 of FIG. 2) and computes coordinate information. For example, the particle system 308 computes and outputs a time-dependent position function that describes the position of an emitted particle throughout the particle' s defined lifetime (or indefinitely if no lifetime is specified). Responsive to receipt to coordinate information for one or more particles, the system threading timers 338 prepare the scene instructions 320 to provide the graphics engine 304 with the coordinate information and other information for rendering the particles in an animated scene.

The graphics engine 304 may assume a variety of forms in different implementations. In FIG. 3, the graphics engine 304 is shown to include a high-level composition and animation engine 324, a low-level composition and animation engine 326, and a graphics subsystem 328, including software and hardware. As used herein, the terms “high-level” and “low-level” are similar to those used in other computing scenarios, wherein in general, the lower a software component is relative to higher components, the closer that component is to the hardware. Thus, for example, graphics information sent from the high-level composition and animation engine 324 may be received at the low-level composition and animation engine 326 where the information is used to send graphics data to a graphics subsystem 328.

In one implementation, the low-level composition and animation engine 326 includes or is otherwise associated with a caching data structure (not shown), such as a structure including a scene graph comprising hierarchically-arranged objects managed according to a defined object model. The scene instructions 320 are conveyed to the high-level composition and animation engine 324 according to a visual API 322 that provides an interface to this caching structure and provides the ability to create objects, open and close objects, provide data to them, and so forth.

In one implementation, the high-level composition and animation engine 324 opens a single object (hereinafter referred to as a “scene object”) to receive all information conveyed in the scene instructions are 320. Among other data, this scene object includes time-dependent position information that allows the high-level composition and animation engine 324 to autonomously produce a series of draw commands that are transmitted, in turn, to the low-level composition and animation engine 326. Each individual one of the draw commands causes the low-level composition and animation engine 326 to control the graphics subsystem 328 to render a complete frame of a same animation within a window of the animation viewing application 318. By transmitting multiple frames of animation data in one set of instructions (e.g., the scene instructions 320) that can be opened as a single object within the high-level composition and animation engine 324, processing overhead is reduced as compared to systems that transmit separate instructions rendering each of several objects side-by-side in a same scene.

In one implementation, the scene instructions 320 are conveyed responsive to emission of a first particle by the particle system 308. For example, the scene instructions 320 include form attribute data for the particle and coordinate information for rendering the particle in different positions over a series of frames spanning the particle's defined lifetime. If and when the particle system 308 emits a new particle, one of the system threading timers 338 transmits an update to the scene instructions 320. If, for example, the scene instructions 320 initially provide for animation of a first particle, an update to the scene instructions 320 may be transmitted responsive to emission of a second particle to communicate form attributes and coordinate information for rendering the second particle, allowing the graphics engine 304 to update the associated scene object within the caching structure of the low-level composition and animation engine 326. When an existing scene object is updated within the high-level composition and animation engine 324, the animation is also updated. For example, a currently-rendering animation of a single particle is updated to include the additional particle(s) without interrupting the animation.

In one implementation, different particles in a same scene are drawn in a predefined order, such as order that the high-level composition and animation engine 324 initially receives the instruction updates pertaining to the addition of each new particle. As a result, the graphics engine 304 does not perform processor-intensive computations to determine layout or rendering orders.

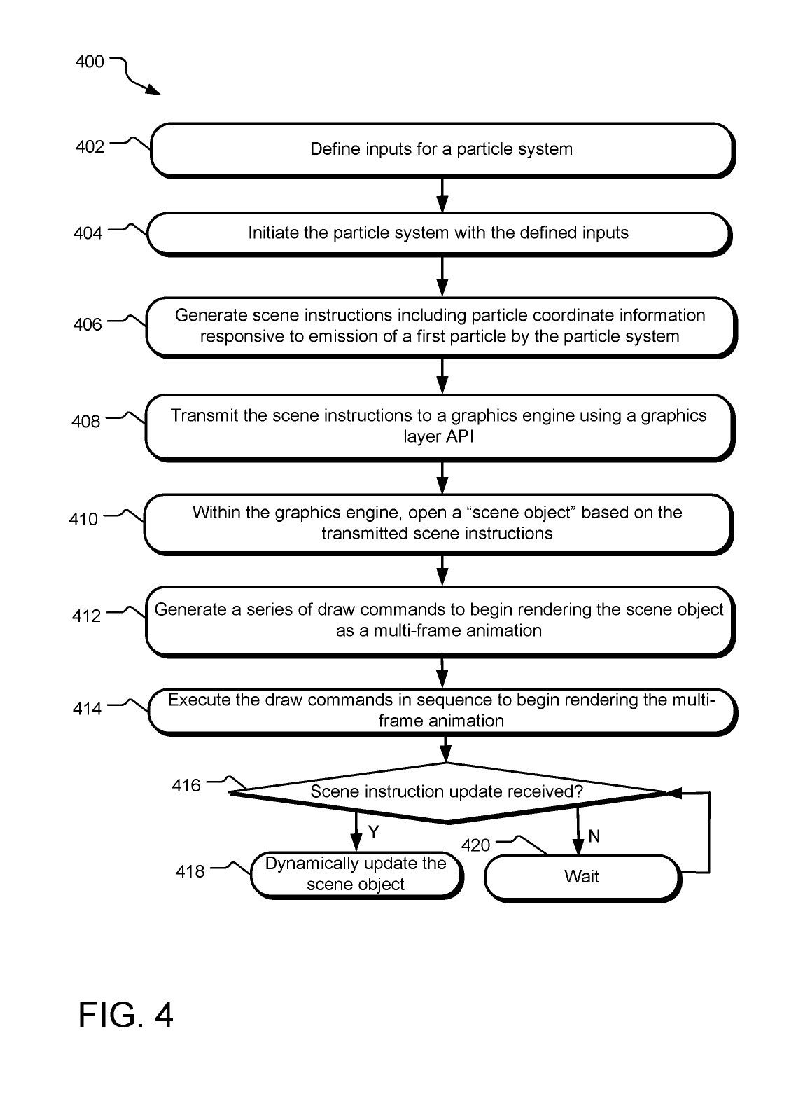

FIG. 4 illustrates example operations 400 for rendering high-resolution animations in low-memory environments. A defining operation 402 defines inputs for a particle system including, for example, particle type identifiers, form attributes, spawning parameters, and behaviors to be applied to each emitted particle. A particle system initiation action 404 initiates a particle system with the defined inputs responsive to an animation rendering request. For example, an animation viewing application may initiate the particle system responsive to receipt of a file included in the defined inputs for the particle system.

A scene instruction creation operation 406 creates scene instructions responsive to emission of a first particle from the particle system. The scene instructions include form attribute data for visually-rendering an image of the particle, as well as coordinate information usable to determine a series of coordinates that the particle assumes (e.g., moves through) throughout its lifetime. For example, the coordinate information includes a time-dependent function describing position of the particle. In one implementation, the scene instructions are communicated to a graphics engine using a visual application programming interface (API) that allows for the creation of new objects and addition of data to existing objects within the graphics engine.

A scene instruction transmission operation 408 communicates the scene instructions to a graphics engine using a graphics layer API, and a scene instruction interpretation operation 410 interprets the received instructions within the graphics engine to open at least one object (e.g., a “scene object”) in a graphics layer associated with the animation rendering request. In one implementation, the graphics engine opens a single scene object and populates the object with data included in the received instructions that is sufficient to render the particle in multiple complete frames of an animation. For example, the scene object may include data sufficient for rendering a particle over a series of frames spanning a defined particle lifetime. If the particle does not have a defined lifetime, the object may be usable to render an endless animation of the particle.

A command creation operation 412 autonomously generates a series of draw commands within the graphics engine that are, collectively, effective to render the scene object as a multi-frame animation. In one implementation, each individual draw command is effective to render a complete frame of the multi-frame animation, where the multi-frame animation depicts the particle moving through a series of positions. Each draw command corresponds to a different frame of the animation, and an associated time index is used to determine the position of the particle within each frame. For example, the particle' s position is determined at each individual frame of the animation by plugging a current time index into a time-dependent position function included within the scene instructions.

A rendering operation 414 begins executing the draw commands in sequence to being rendering the multi-frame animation to an application window on a user interface.

A determination operation 416 determines whether an update to the scene instructions has been received, such as an update to add a new particle to the animation being rendered. If such an update is received, an object modifier 418 dynamically modifies (e.g., updates) the scene object in memory (e.g., within the graphics layer) to add information specified in the update, such as to modify the scene to include a second moving object. The animation is altered without interruption to reflect the updates. If the determination operation 416 determines that an update to the scene instructions has not yet been received, a wait operation 420 commences until an update to the scene instructions is received or the animation ends.

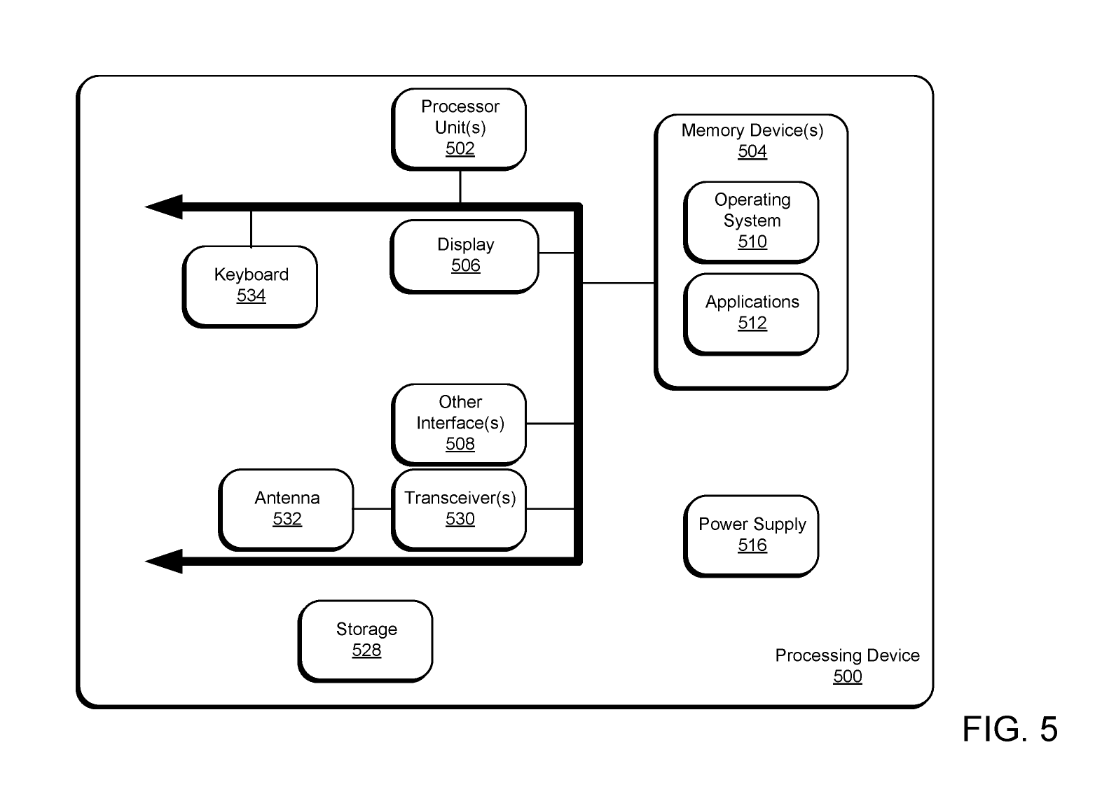

FIG. 5 illustrates an example schematic of a processing device 500 operable to render a high-resolution animation according to the technology described herein. The processing device 500 includes one or more processing unit(s) 502, one or more memory device(s) 504, a display 506, and other interfaces 508 (e.g., buttons). The memory 504 generally includes both volatile memory (e.g., RAM) and non-volatile memory (e.g., flash memory). An operating system 510, such as the Microsoft Windows® operating system, the Microsoft Windows® Phone operating system or a specific operating system designed for a gaming device, resides in the memory 504 and is executed by the processing unit(s) 502, although it should be understood that other operating systems may be employed.

One or more applications 512, such as a dimensional surface content rendering tool or animation viewing application are loaded in the memory 504 and executed on the operating system 510 by the processing unit(s) 502. The processing device 500 includes a power supply 516, which is powered by one or more batteries or other power sources and which provides power to other components of the processing device 500. The power supply 516 may also be connected to an external power source that overrides or recharges the built-in batteries or other power sources. The processing device 500 includes one or more communication transceivers 530 and an antenna 532 to provide network connectivity (e.g., a mobile phone network, Wi-Fi®, BlueTooth®). The processing device 500 may also include various other components, such as a keyboard 534, a positioning system (e.g., a global positioning satellite transceiver), one or more accelerometers, one or more cameras, an audio interface, and storage devices 528. Other configurations may also be employed.

The processing device 500 may include a variety of tangible computer-readable storage media and intangible computer-readable communication signals. Tangible computer-readable storage can be embodied by any available media that can be accessed by the processing device 500 and includes both volatile and non-volatile storage media, removable and non-removable storage media. Tangible computer-readable storage media excludes intangible and transitory communications signals and includes volatile and non-volatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

An example system disclosed herein includes a dimensional surface content rendering tool, an application, and a graphics engine. The dimensional surface content rendering tool is configured to generate an animation object file defining inputs to a particle system, and the application is configured to generate scene instructions based on output received from the particle system that include coordinate information for rendering an object at a series of positions, The graphics engine is configured to autonomously produce a series of draw commands responsive to receipt of the scene instructions to render multiple complete frames of an animation in a window of the application depicting the object at the series of positions.

In an example system of any preceding system, the scene instructions to the graphics engine are transmitted via a graphics layer application programming interface (API).

In another example system of any preceding system, the coordinate information includes information for rendering multiple objects that move with respect to one another throughout the animation.

In still another example system of any preceding system, the animation object file defines at least one predefined behavior to be applied to a particle emitted by the particle system.

In another example system of any preceding system, the coordinate information includes a time-dependent position function for the object.

In yet another example system of any preceding system, the object corresponds to a first particle emitted by the particle system and the application receives additional coordinate information received from the particle system while the animation is being rendered in the window of the application. The additional coordinate information describes a time-dependent position function for second particle emitted by the particle system. The applicant then communicates updated scene instructions to the graphics engine responsive to receipt of the additional coordinate information at the application. The updated scene instructions are effective to add the second particle to the animation without disrupting the animation.

In another example system of any preceding system, the application is a low-memory application.

In yet another example system of any preceding system, the animation is an interactive animation.

An example method disclosed herein includes receiving output from a particle system including coordinate information describing a series of positions for at least one object;

communicating scene instructions from an application to a graphics engine, the scene instructions including the coordinate information from the particle system and effective to autonomously generate a series of draw commands within the graphics engine to render multiple complete frames of an animation within a window of the application; and executing the communicated scene instructions within the graphics engine to render the animation within the window of the application, the animation including the at least one object moving through the series of positions.

In an example method of any preceding method, the communicated scene instructions include coordinate information for rendering multiple objects that move with respect to one another throughout the animation.

In yet another example method of any preceding method, the method further includes defining inputs to the particle system that specify at least one predefined behavior affecting controlling movement of an associated particle throughout a predefined lifetime.

In still another example method of any preceding method, the coordinate information includes a time-dependent position function.

In yet another example method of any preceding method, the method further includes receiving an animation object file generated by a dimensional surface content rendering tool, the animation object file defining one or more particle objects of a particle system; and initializing the particle system based on the particle objects defined in the animation object file.

In another example method of any preceding method, the at least one object corresponds a first particle spawned by the particle system.

In another example method of any preceding method, the object corresponds to a first particle emitted by the particle system and the method further includes receiving additional coordinate information from the particle system while the animation is being rendered in the window of the application, the additional coordinate information including a time-dependent position function for second particle emitted by the particle system; and communicating updated scene instructions to the graphics engine responsive to receipt of the additional coordinate information at the application, the updated scene instructions effective to add the second particle to the animation without disrupting the animation.

In another example method of any preceding method, the application is a low-memory application.

An example computer-readable storage media disclosed herein includes a tangible article of manufacture encoding computer-executable instructions for executing on a computer system a computer process comprises receiving output from a particle system including coordinate information describing a series of positions for at least one object; communicating scene instructions from an application to a graphics engine, the scene instructions including the coordinate information from the particle system and effective to autonomously generate a series of draw commands within the graphics engine to render multiple complete frames of an animation within a window of the application; and executing the communicated scene instructions within the graphics engine to render the animation within the window of the application, the animation including the at least one object moving through the series of positions.

An example computer process according to any preceding computer process further comprises receiving an animation object file generated by a dimensional surface content rendering tool, the animation object file defining one or more particle objects of a particle system; and initializing the particle system based on the particle objects defined in the animation object file.

In still another example computer process of any preceding computer process, the object corresponds to a first particle emitted by the particle system and the computer process further comprises: receiving additional coordinate information from the particle system while the animation is being rendered in the window of the application, the additional coordinate information including a time-dependent position function for second particle emitted by the particle system; and communicating updated scene instructions to the graphics engine responsive to receipt of the additional coordinate information of the application, the updated scene instructions effective to add the second particle to the animation without disrupting the animation.

In still another example computer process of any preceding computer process, the application is a low-memory application.

An example method disclosed herein includes a means for receiving output from a particle system including coordinate information describing a series of positions for at least one object and a means for communicating scene instructions from an application to a graphics engine. The scene instructions include the coordinate information from the particle system and are effective to autonomously generate a series of draw commands within the graphics engine to render multiple complete frames of an animation within a window of the application. The system further includes a means for executing the communicated scene instructions within the graphics engine to render the animation within the window of the application, the animation including the at least one object moving through the series of positions.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

1. A system comprising:
memory;
at least one processor;
a dimensional surface content rendering tool stored in the memory and executable by the at least one processor to generate an animation object file defining inputs to a particle system;
an application stored in the memory and executable by the at least one processor to generate scene instructions based on output received from the particle system, the scene instructions including coordinate information defining a time-dependent position function for rendering an object at a series of positions; and
a graphics engine that receives the scene instructions from the application and utilizes the time-dependent position function to autonomously produce a series of draw commands responsive to receipt of the scene instructions to render multiple complete frames of an animation in a window of the application, the animation depicting the object at the series of positions.

2. The system of claim 1, wherein the scene instructions to the graphics engine are transmitted via a graphics layer application programming interface (API).

3. The system of claim 1, wherein the coordinate information includes information for rendering multiple objects that move with respect to one another throughout the animation.

4. The system of claim 1, wherein the animation object file defines at least one predefined behavior to be applied to a particle emitted by the particle system.

5. (canceled)

6. The system of claim 1, wherein the object corresponds to a first particle emitted by the particle system and the application is further configured to:
receive additional coordinate information received from the particle system while the animation is being rendered in the window of the application, the additional coordinate information describing the time-dependent position function for a second particle emitted by the particle system; and
communicate updated scene instructions to the graphics engine responsive to receipt of the additional coordinate information of the application, the updated scene instructions effective to add the second particle to the animation without disrupting the animation.

7. The system of claim 1, wherein the application is a low-memory application.

8. The system of claim 1, wherein the animation is an interactive animation.

9. A method comprising:
receiving output from a particle system including coordinate information defining a time-dependent position function for rendering at least one object at a a series of positions;
communicating scene instructions from an application to a graphics engine, the scene instructions including the coordinate information from the particle system and effective to autonomously generate a series of draw commands within the graphics engine to render multiple complete frames of an animation within a window of the application; and
executing the communicated scene instructions within the graphics engine to render the animation within the window of the application, the animation including the at least one object moving through the series of positions defined by the time-dependent position function.

10. The method of claim 9, wherein the communicated scene instructions include coordinate information for rendering multiple objects that move with respect to one another throughout the animation.

11. The method of claim 9, further comprising:
defining inputs to the particle system, the inputs specifying at least one predefined behavior affecting controlling movement of an associated particle throughout a predefined lifetime.

12. (canceled)

13. The method of claim 9, further comprising:
receiving an animation object file generated by a dimensional surface content rendering tool, the animation object file defining one or more particle objects of a particle system; and
initializing the particle system based on the particle objects defined in the animation object file.

14. The method of claim 9, wherein the at least one object corresponds to a first particle spawned by the particle system.

15. The method of claim 14, wherein the object corresponds to a first particle emitted by the particle system and the method further comprises:
receiving additional coordinate information from the particle system while the animation is being rendered in the window of the application, the additional coordinate information including a time-dependent position function for a second particle emitted by the particle system; and
communicating updated scene instructions to the graphics engine responsive to receipt of the additional coordinate information of the application, the updated scene instructions effective to add the second particle to the animation without disrupting the animation.

16. The method of claim 9, wherein the application is a low-memory application.

17. One or more computer-readable storage media of a tangible article of manufacture encoding computer-executable instructions for executing on a computer system a computer process comprising:
receiving output from a particle system including coordinate information that defines at least one time-dependent position function useable to determine a series of positions for at least one object;
communicating scene instructions from an application to a graphics engine, the scene instructions including the coordinate information from the particle system and effective to autonomously generate a series of draw commands within the graphics engine to render multiple complete frames of an animation within a window of the application; and
executing the communicated scene instructions within the graphics engine to render the animation within the window of the application, the animation including the at least one object moving through the series of positions defined by the time-dependent position function.

18. The computer-readable storage media of claim 17, wherein the computer process further comprises:
receiving an animation object file generated by a dimensional surface content rendering tool, the animation object file defining one or more particle objects of a particle system; and
initializing the particle system based on the particle objects defined in the animation object file.

19. The computer-readable storage media of claim 17, wherein the object corresponds to a first particle emitted by the particle system and the computer process further comprises:
receiving additional coordinate information from the particle system while the animation is being rendered in the window of the application, the additional coordinate information including a time-dependent position function for a second particle emitted by the particle system; and
communicating updated scene instructions to the graphics engine responsive to receipt of the additional coordinate information at the application, the updated scene instructions effective to add the second particle to the animation without disrupting the animation.

20. The computer-readable storage media of claim 17, wherein the application is a low-memory application.
